(19) United States
(12) Patent Application Publication
(10) Pub. No.: US 2020/0332575 A1
(43) Pub. Date: Oct. 22, 2020

(54) DOOR HANDLE ASSEMBLY OF A MOTOR VEHICLE

(71) Applicants: Mario Christensen, Muelheim (DE); Axel Speer, Remscheid (DE)

(72) Inventors: Mario Christensen, Muelheim (DE); Axel Speer, Remscheid (DE)

(73) Assignee: Huf Huelsbeck & Fuerst GmbH & Co. KG, Velbert (DE)

(21) Appl. No.: 16/766,063

(22) PCT Filed: Oct. 31, 2018
(86) PCT No.: PCT/EP2018/079895

§ 371 Date: May 21, 2020

(30) Foreign Application Priority Data
Dec. 19, 2017 (DE) 10 2017 130 573.4

(51) Int. Cl. E05B 85/10; E05B 85/18

(52) U.S. Cl. CPC E05B 85/107; E05B 81/90; E05B 85/18

(57) ABSTRACT

A motor vehicle door handle assembly includes a carrier, a handle body, pivotable about an axis of rotation and movable from an idle position into an end position, and a force-increasing device, which, during movement of the handle body from the idle position into the intermediate position, produces a resistance force counteracting the movement of the handle body. The force-increasing device includes a force-increasing element, producing the resistance force and fastened to the handle body, a resistance element, interacting with the force-increasing element and mounted on the handle body, and a movement element, which, during movement of the handle body from the idle position into the intermediate position, moves the resistance element translationally toward the force-increasing element against the resistance force produced by the force-increasing element and, during movement of the handle body from the end position into the idle position, moves the resistance element rotationally.

The invention relates to a door handle assembly of a motor vehicle, comprising a carrier which can be fastened on a door or trunk lid of the motor vehicle, a handle body, which is mounted on the carrier for pivoting about an axis of rotation and can be moved from an idle position into an end position, and a force-increasing device, which is designed, during movement of the handle body from the idle position until the attainment of the intermediate position, to produce a resistance force counteracting the movement of the handle body.

A door handle assembly of the type described in the introduction is known, for example, from EP 1 819 892 B1. In this known door handle assembly, a resistance device becomes effective at the end of a first actuation path of a manually operated handle body, which temporarily increases the actuation resistance, so that a switch for the electrical opening of the door lock is actuated and the door lock is opened electrically only after or upon overcoming a noticeable pressure point. If the handle is deflected beyond the first actuation path along a second actuation path, the door lock is opened mechanically in an emergency, such as, for example, in the case of an empty vehicle battery, wherein this requires an actuation force that is greater than the force necessary for the electrical opening. Due to the construction of the door handle assembly of EP 1 819 892 B1, an increased actuating force of the handle body is required for normal operation of the door handle assembly in order to reach or overcome the pressure point and to open the door lock electrically, which disadvantageously limits the comfort of the door handle assembly.

The invention has for its object to provide a solution which provides an improved door handle assembly in a structurally simple manner, by means of which the disadvantages mentioned at the outset are avoided and by means of which a more comfortable handling for the user is possible.

In a door handle assembly of a motor vehicle of the type described in the introduction, the object is achieved according to the invention in that the force-increasing device comprises a force-increasing element, which produces the resistance force and is fastened to the handle body, a resistance element, which interacts with the force-increasing element and is mounted on the handle body, and a movement element, which is designed, during movement of the handle body from the idle position until the attainment of the intermediate position, to move the resistance element translationally toward the force-increasing element against the resistance force produced by the force-increasing element relative to the axis of rotation and, during movement of the handle body from the end position into the idle position, to move the resistance element rotationally relative to a rotational axis of the handle body. The axis of rotation is fixed on the handle body or the resistance element rotates about the rotational axis arranged on the handle body. In the sense of the invention, a translational movement means a movement in which the resistance element moves linearly to the axis of rotation of the handle body, so that the resistance element is displaced linearly to the axis of rotation. Furthermore, in the sense of the invention, a rotational movement is understood to mean a movement in which the resistance element is rotated about the rotational axis.

Advantageous and expedient embodiments and developments of the invention are disclosed in the dependent claims.

The invention provides a door handle assembly which is distinguished by a simple construction. In the door handle assembly according to the invention, a door lock of the door of the motor vehicle can be opened electrically before or when the intermediate position of the handle body is reached, such that the user does not have to exert an increased force as in the prior art. As a result, the door lock can be opened electrically with minimal effort. According to the invention, the force-increasing element generating the resistance force is only effective when the handle body is moved from the idle position into the intermediate position. In this way, the user of the door handle assembly receives feedback that is perceptible to him/her, wherein the intermediate position does not have to be reached by the user in order for the door lock to be opened electrically. The intermediate position only has to be reached and overcome by the user when a currentless emergency actuation is required, as a result of which the door lock can be opened purely mechanically with the aid of an actuation of the handle body, which is coupled to the door lock via a Bowden cable, for example. Since the force-increasing element is only effective during movement of the handle body from the idle position into the intermediate position, the user of the door handle assembly does not have to use any increased actuation force by the force-increasing device for the mechanical emergency opening of the door lock, which facilitates the operation of the door handle assembly according to the invention in emergency operation. According to the invention, consequently, when the handle body is actuated from the idle position toward the end position, an actuating force is applied by means of which the resistance element is moved in a translational direction toward the force-increasing element. This increase in force is only present until attainment of the intermediate position. As soon as the intermediate position is exceeded and the handle body is moved further towards its end position, the user can no longer feel any increase in force. The resistance element is arranged in the movement path of the movement element both during movement of the handle body from the idle position into the end position and during movement of the handle body from the end position into the idle position, such that the movement element strives according to the invention to press the resistance element out of its movement path. The handle body is usually prestressed into its idle position by means of a spring element, so that after the user acts upon an actuating force, the handle body strives to return to its idle position. For a movement of the handle body from the end position into the idle position, this spring element can be dimensioned small, because when the handle body moves back into the idle position, the resistance element on the handle body is not moved transationally, but rotationally, as for the movement toward the end position, which is why much less force is required.

In an embodiment of the door handle assembly according to the invention, it is provided that the movement element is designed as a movement projection projecting from a base body mounted on the carrier. The movement projection can be designed in the manner of a lever arm which interacts with the resistance element when the handle body moves.

In a further embodiment of the door handle assembly, the invention provides that the movement element is pivotably mounted on the carrier via a pivot axis, the handle body and the movement element being coupled together so as to transmit a movement in a rotating manner during movement of the handle body in contrary directions about the axis of rotation and the pivot axis. In this case, the movement element is designed as a mass balancing element which, in the event of a vehicle accident, ensures that the handle body does not reach a position in which the door lock can be opened due to acceleration forces acting in case of the accident.

In a further embodiment of the invention, it is structurally particularly favorable for an opposite rotary movement of the handle body and the movement element if the handle body has at least one pivot lever connected to the axis of rotation, on which a coupling recess is formed, wherein the movement element has at least one coupling arm, on which a coupling projection is formed, which is arranged in the coupling recess of the at least one pivot lever of the handle body.

For the interaction of the resistance element with the force-increasing element, there is a structurally advantageous possibility that the resistance element has a functional body having a support surface, wherein the functional body is inserted at least in sections in a receiving frame formed on the handle body and the force-increasing element is arranged between the support surface of the functional body and a mounting surface formed on the handle body.

For the arrangement of the resistance element on the handle body, the invention provides in an embodiment of the door handle assembly that the functional body of the resistance element has at least one support element projecting laterally from the functional body, wherein the at least one support element is arranged lying on the receiving frame in the idle position of the handle body and the force-increasing element presses the supporting element onto the receiving frame. This position of the resistance element when the force-increasing element presses the at least one support element onto the receiving frame can be regarded as a basic position of the resistance element.

In a further embodiment of the door handle assembly according to the invention, it is provided that the handle body has at least one first guide surface and at least one second guide surface which is parallel to the at least one first guide surface, wherein a ramp surface is formed on the functional body, which is formed on the side of the functional body facing away from the support surface and which rises in a direction pointing towards the carrier. The functional body is arranged between the at least one first guide surface and the at least one second guide surface. The guide surfaces serve to allow the functional body of the resistance element to be moved linearly along and between the guide surfaces.

In a further embodiment of the invention, it is particularly advantageous if, during movement of the handle body from the idle position into the intermediate position, the movement element rests on the ramp surface and the functional body of the resistance element is designed to be linearly movable against the resistance force of the force-increasing element toward the force-increasing element with respect to the axis of rotation of the handle body along the at least one first guide surface and the at least one second guide surface.

The movement of the functional body of the resistance element is brought about by the movement element, the invention providing in a further embodiment in this regard that during movement of the handle body from the idle position into the intermediate position, the movement element is designed to abut and move linearly with respect to the axis of rotation of the handle body along the ramp surface, wherein during movement of the handle body beyond the intermediate position up to the end position, the movement element is spaced apart from the ramp surface beyond the intermediate position up to the end position and the at least one support element is arranged lying on the receiving frame. The movement element thus comes into contact with the ramp surface during movement of the handle body from the idle position into the intermediate position and presses the resistance element toward the force-increasing element, the force-increasing element generating the resistance force during the movement of the resistance element.

For a rotational movement of the resistance element, in a further embodiment of the door handle assembly according to the invention it is provided that two pivot pins are formed on two opposite sides of the functional body of the resistance element, which are rotatably mounted at least in the idle position of the handle body in corresponding bearing receptacles, which are formed in the receiving frame of the handle body, wherein the pivot pins form the rotational axis.

With regard to the rotational movement of the resistance element, the invention provides that during movement of the handle body from a position lying between the intermediate position and the end position into the idle position, the movement element comes into contact with the functional body and is designed to rotationally move the functional body having its two pivot pins arranged in the corresponding bearing receptacles against the direction of rotation of the handle body in the bearing receptacles with respect to the rotational axis.

Finally, it is advantageous for guiding the rotational movement if the functional body has two guide arms formed on opposite sides and angled and the handle body has two guide recesses which extend in an actuation direction of the handle body, wherein during movement of the handle body from a position lying between the intermediate position and the end position toward the idle position, the two guide arms are arranged lying and guided in the guide recesses of the handle body.

It goes without saying that the features mentioned above and those to be explained below can be used not only in the combination indicated but also in other combinations or alone, without leaving the scope of this invention. The scope of the invention is defined only by the claims.

Other details, features, and advantages of the subject matter of the invention can be found in the following description in connection with the drawing in which an exemplary and preferred embodiment of the invention is shown.

In the drawings:

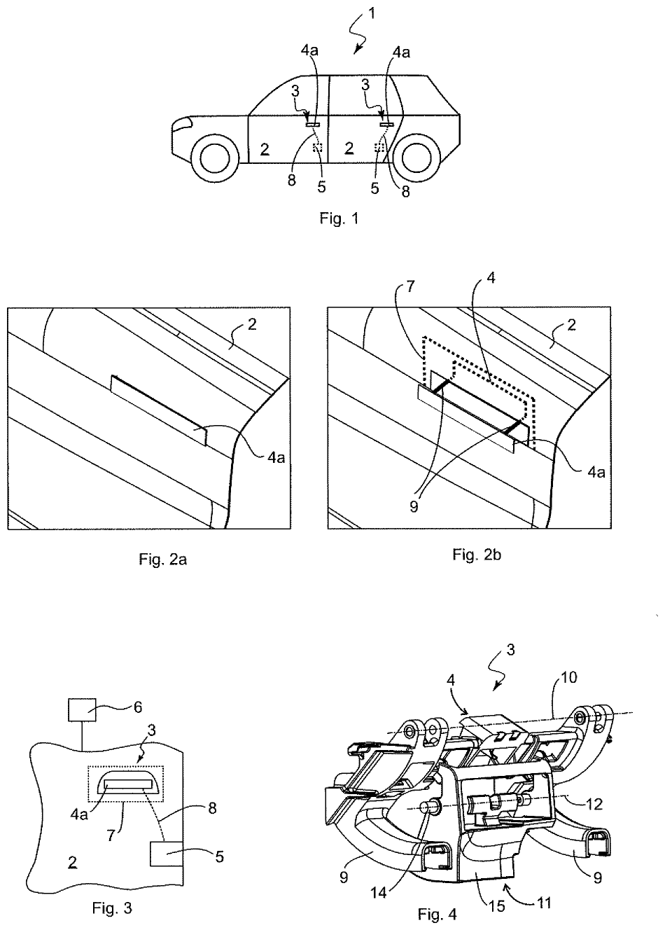

FIG. 1 is a side view of a motor vehicle having a plurality of door handle assemblies according to the invention,

FIG. 2a shows a door of the motor vehicle having a handle body which is mounted on a carrier and which is arranged in an idle position,

FIG. 2b shows the door of the motor vehicle with the handle body mounted on the carrier, which is arranged in an end position,

FIG. 3 is a schematic illustration of a door with the door handle assembly arranged thereon and a door lock,

FIG. 4 is a front view of the door handle assembly according to the invention without a carrier,

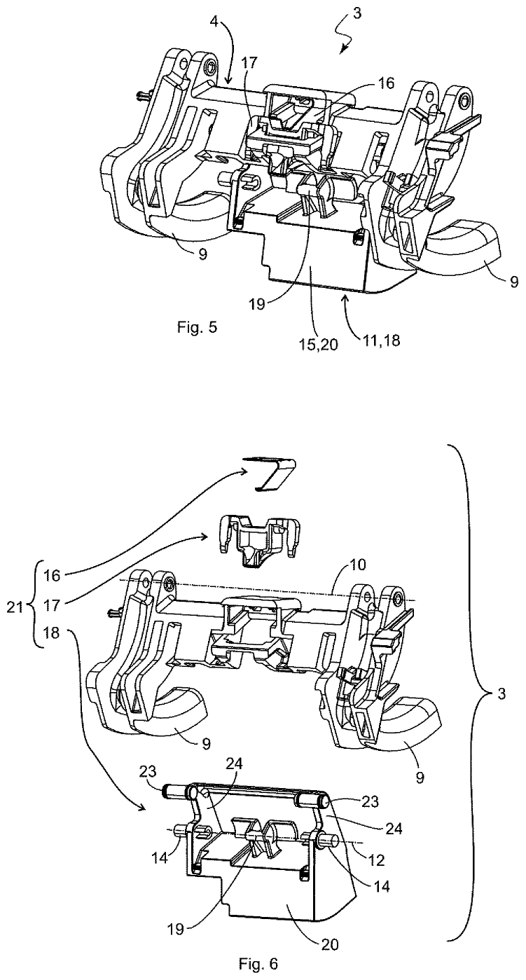

FIG. 5 is a rear view of the door handle assembly shown in FIG. 4,

FIG. 6 is a perspective partial illustration of the door handle assembly according to the invention, wherein the carrier is omitted,

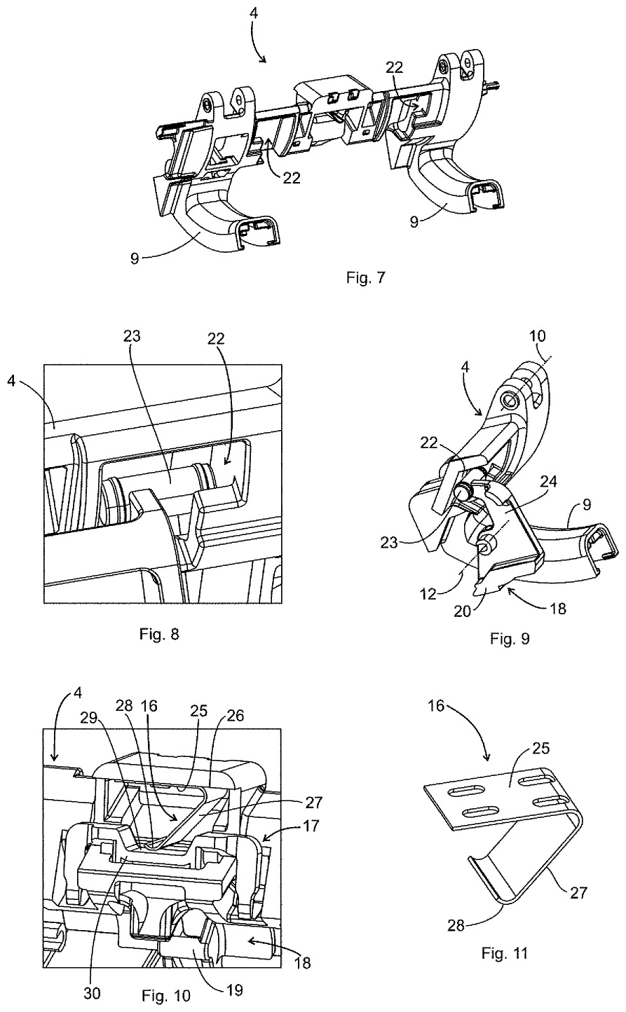

FIG. 7 is a perspective view of the handle body of the door handle assembly,

FIG. 8 is an enlarged detailed view of the handle body and a movement element interacting with the handle body,

FIG. 9 is a perspective sectional view of the handle body and movement element,

FIG. 10 is a further perspective detail view of the handle body with a resistance element mounted thereon, on which a force-increasing element presses.

FIG. 11 is a perspective view of the force-increasing element,

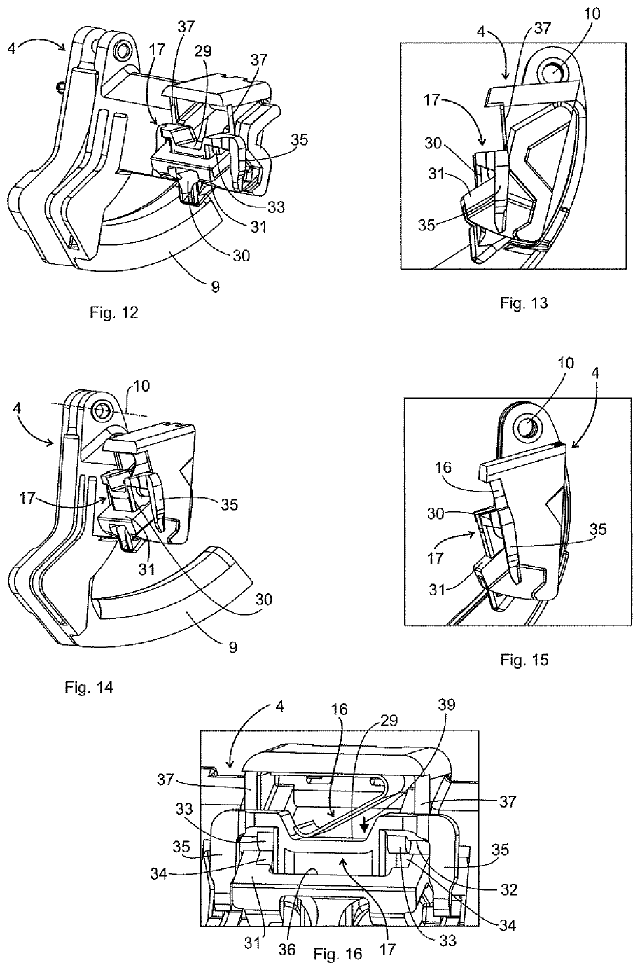

FIG. 12 is a perspective sectional illustration of the handle body in the idle position and the resistance element mounted on the handle body,

FIG. 13 is a side view of the illustration from FIG. 12,

FIG. 14 is a perspective sectional illustration of the handle body and the resistance element, which was moved lineardy,

FIG. 15 is a side view of FIG. 14,

FIG. 16 is a detailed view of the illustration from FIG. 14,

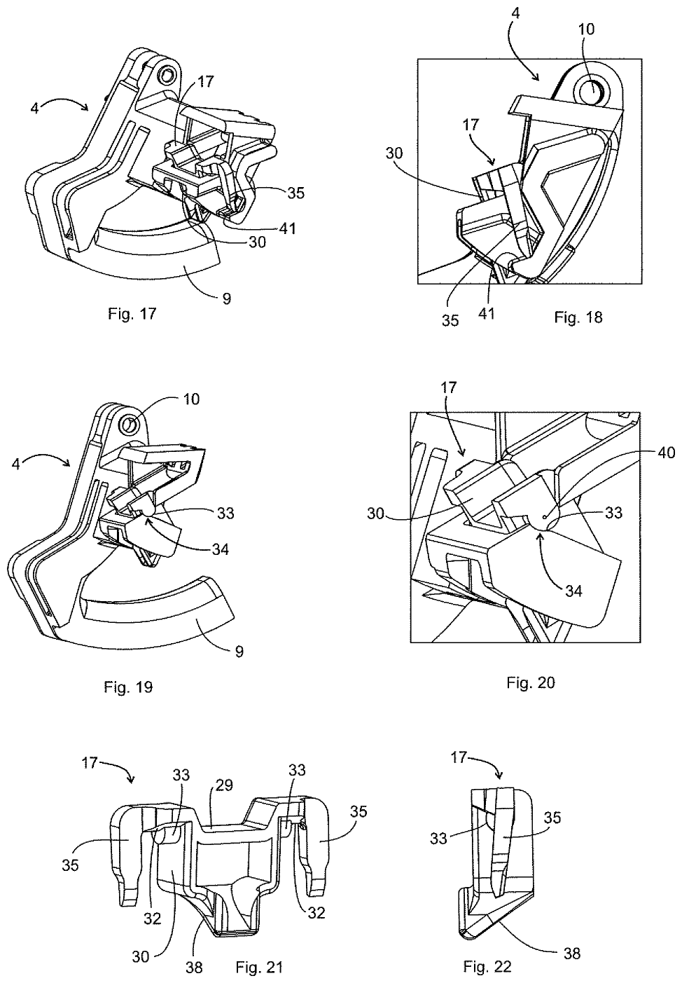

FIG. 17 is a perspective sectional illustration of the handle body and the resistance element, which has been rotationally moved,

FIG. 18 is a side view of FIG. 17,

FIG. 19 is a further perspective sectional illustration of the handle body and the resistance element, which has been rotationally moved,

FIG. 20 is a detailed view of FIG. 19,

FIG. 21 is a perspective view of the resistance element,

FIG. 22 is a side view of the resistance element from FIG. 21,

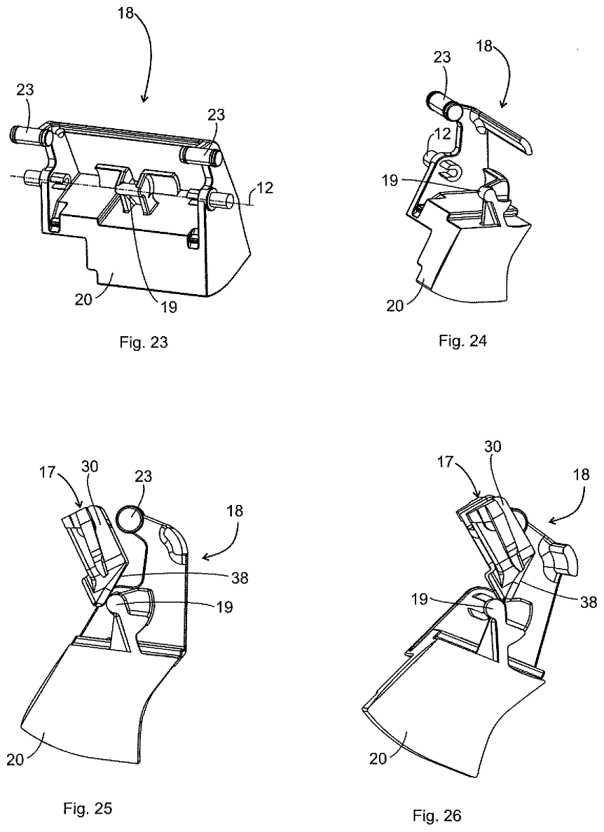

FIG. 23 shows a perspective sectional representation of the movement element,

FIG. 24 is a sectional view of the movement element from FIG. 23,

FIG. 25 is a side sectional view of the movement element and the resistance element during movement of the handle body from the idle position toward an intermediate position,

FIG. 26 is a sectional side view of the movement element and the resistance element during movement of the handle body from an end position toward the idle position,

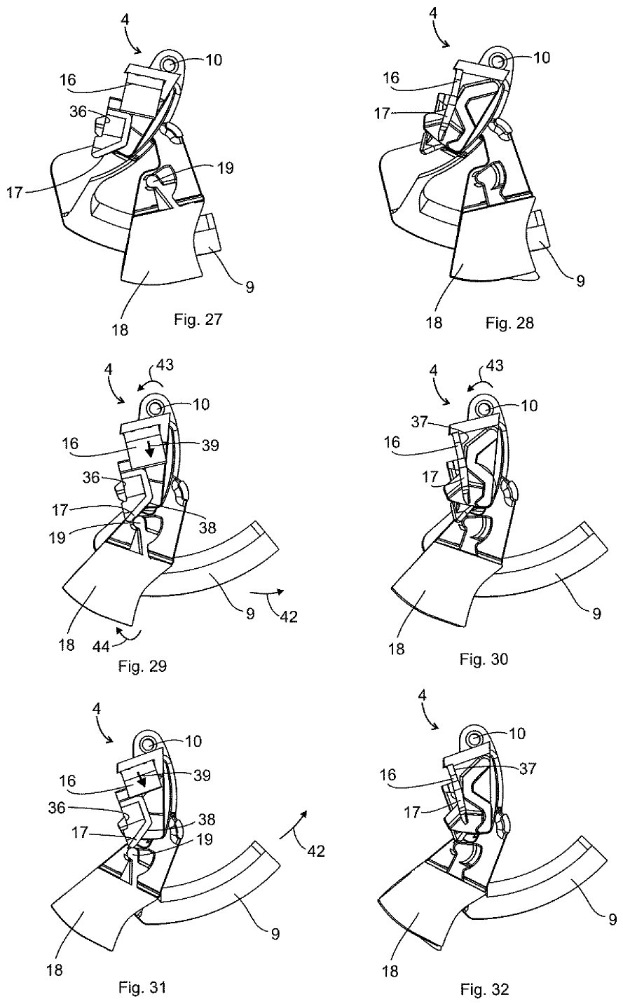

FIG. 27 is a sectional side view of the door handle assembly without the carrier, wherein the handle body is arranged in the idle position,

FIG. 28 is a further sectional side view of the door handle assembly without the carrier, the handle body being arranged in the idle position,

FIG. 29 is a sectional side view of the door handle assembly without the carrier, the handle body being arranged in a position between the idle position and the intermediate position,

FIG. 30 is a further sectional side view of the door handle assembly without the carrier, the handle body being arranged in the position shown in FIG. 29,

FIG. 31 is a sectional side view of the door handle assembly without the carrier, the handle body being arranged in the intermediate position,

FIG. 32 is a further sectional side view of the door handle assembly without the carrier, the handle body being arranged in the position shown in FIG. 31,

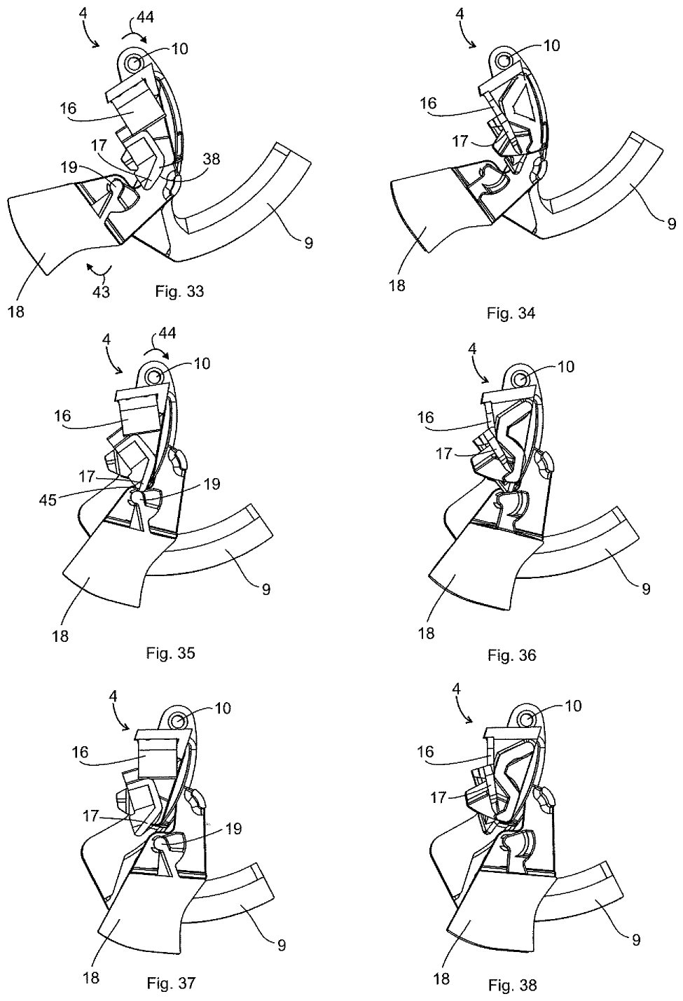

FIG. 33 is a sectional side view of the door handle assembly without the carrier, the handle body being arranged in an end position,

FIG. 34 is a further sectional side view of the door handle assembly without the carrier, the handle body being arranged in the position shown in FIG. 33,

FIG. 35 is a side sectional view of the door handle assembly without the carrier, the handle body being arranged to be moved from the end position toward the intermediate position,

FIG. 36 is a further sectional side view of the door handle assembly without the carrier, the handle body being arranged in the position shown in FIG. 35,

FIG. 37 is a side sectional view of the door handle assembly without the carrier, the handle body being arranged to be moved from the intermediate position toward the end position, and

FIG. 38 is a further sectional side view of the door handle assembly without the carrier, the handle body being arranged in the position shown in FIG. 37.

FIG. 1 is an example of a vehicle or motor vehicle 1 in the form of a car, which in the example has four doors 2 (two of which can be seen in FIG. 1), which have a door handle assembly 3 and in particular can be opened with the aid of a handle part 4a attached to a handle body 4 (see for example FIG. 2b). With reference to FIGS. 1 to 3, the doors 2 are closed by respective door locks 5 and can be opened from the outside by actuating the handle body 4 or handle part 4a in each case. The handle body 4 has the handle part 4a which can be gripped from behind, which can be actuated to open the door lock 5, the actuation in the exemplary embodiment shown in the drawings being a pulling force of a user exerted on the handle body 4 or on the handle part 4a. To open the door 2, the handle body 4 is then pivoted to a certain extent during normal operation, as a result of which a switch is actuated, which in turn activates an electromechanical locking system 6 (see FIG. 3), with the aid of which the door lock 5 can then be opened electrically. When the handle body 4 is pivoted to a certain extent in order to electrically open the door lock 5, the handle body 4 is moved from an idle position toward an end position. The electrical opening can take place before an intermediate position is reached, in the intermediate position or after the intermediate position has been passed, but before the attainment of the end position.

It can be seen from FIG. 2a that the handle part 4a of the handle body 4 is arranged on the outside on the door 2 of the motor vehicle 1, the handle part 4a being accessible by a user. FIG. 2a shows a position in which the handle body 4 is arranged in the idle position. For coupling the handle body 4 to the door 2, a frame-like carrier 7 is provided, which is only shown schematically and in dashed lines in FIGS. 2b and 3, since it is arranged on the inside of the door 2 and thus covered by the door 2 in FIGS. 1 to 3. The carrier 7 is fastened on the inside to the door 2 via known fastening means and supports the handle body 4 with its handle part 4a arranged on the outside of the door 2. In other words, the carrier 7 is known for the attachment and storage of the handle body 4 and is fastened to the inside of the door 2 by means of screw connections (not shown). For reasons of material savings, the carrier 7 is predominantly formed by a frame structure which has various receiving and storage spaces, in addition to the handle body 4, which is mounted on the carrier 7 for opening a corresponding door 2 of the motor vehicle 1, for example to be able to receive a locking cylinder. In FIG. 2b, the handle part 4a is pivoted beyond the intermediate position into an end position. In the end position, the door 2 can be opened mechanically, which is achieved by a Bowden cable system 8 (see, for example, FIGS. 1 and 3) which mechanically operatively interconnects the door lock 5 and the handle body 4. Mechanical opening is only necessary in a currentless emergency operation, because in normal operation the door lock 5 is opened electrically at the latest before attainment of the intermediate position or upon attainment of the intermediate position or shortly after exceeding the intermediate position and before attainment of the end position of the handle body 4.

FIG. 4 shows the door handle assembly 3 according to the invention in a perspective view, the illustration of the carrier 7 and the handle part 4a being omitted for reasons of clarity. The handle body 4 has two pivot levers 9 which are arranged at a distance from one another and to which the handle part 4a is detachably fastened. The two pivot levers 9 of the handle body 4 are angled and L-shaped. The handle body 4 having its two pivot levers 9 is pivotally mounted on the carrier 7 about an axis of rotation 10, so that a user can pivot the handle body 4 about the axis of rotation 10 by a manual pulling movement on the handle part 4a and can move the handle body 4 from an idle position via an intermediate position to an end position. A mass balancing element 11 is also rotatably mounted on the carrier 7, which at least contributes to or prevents the handle body 4 from being deflected and the door lock 5 from unintentionally opening as a result of acting acceleration forces which act on the motor vehicle 1 in the event of an accident. The mass balancing element 11 is rotatably mounted on the carrier 7 via a pivot axis 12 which is formed by laterally projecting pins 14 (only one of the two pins 14 can be seen in FIG. 4) and which runs parallel to the axis of rotation 10, wherein the mass balancing element 11 has a balancing mass 15, which is arranged between the two pivot levers 9 of the handle body 4.

FIG. 5 shows the door handle assembly 3 from FIG. 4 in a rear view, whereas FIG. 6 shows a perspective individual part representation of the door handle assembly 3. It should be noted that for the door handle assembly 3 according to the invention in FIGS. 5 to 38, for reasons of clarity, the carrier 7 and the handle part 4a are not shown. As can be seen from FIGS. 5 and 6, the door handle assembly 3 has a force-increasing element 16 fastened to the handle body 4 and a resistance element 17 which interacts with the force-increasing element 16 and is movably mounted on the handle body 4. A movement element 18 interacts with the resistance element 17, which in the exemplary embodiment shown is the mass balancing element 11, so that the movement element 18 is pivotably mounted on the carrier 7 via the pivot axis 12. Alternatively, the movement element 18 could also be formed on the carrier 7. For the interaction of the movement element 18 with the resistance element 17, the movement element 18 has a movement projection 19 which is formed on the balancing mass 15 toward the movement element 18, the balancing mass 15 simultaneously representing a base body 20 for the movement element 18. The force-increasing element 16, the resistance element 17, and the movement element 18 together form a force-increasing device 21, which is designed such that during movement of the handle body 4 from the idle position until the attainment of the intermediate position, a resistance force which counteracts the movement of the handle body 4 is generated, whereas during movement of the handle body 4 beyond the intermediate position toward the end position and during movement of the handle body 4 from a position lying between the end position and the intermediate position toward the idle position, the force-increasing element 16 does not generate any resistance force.

FIGS. 7 to 9 show details that relate to a coupling of the handle body 4 and the movement element 18. This is because the movement element 18 is coupled to the handle body 4 so as to transmit a movement in such a way that the handle body 4 and the movement element 18 rotate in contrary directions during movement of the handle body 4. If the handle body 4 is pivoted counterclockwise about the axis of rotation 10, for example by actuation of a user, the movement element 18 rotates clockwise about the pivot axis 12 as a result of the movement coupling. The handle body 4 and the movement element 18 are coupled together so as to transmit a movement and rotate in contrary directions about the axis of rotation 10 and the pivot axis 12 during movement of the handle body 4. For this purpose, a coupling recess 22 (see, for example, FIG. 7) is formed on each of the two pivot levers 9 of the handle body 4, wherein alternatively a single coupling recess would also be sufficient to couple the handle body 4 to the movement element 18. Two laterally projecting coupling projections 23 are formed on the movement element 18 and extend parallel to the pivot axis 12 (see for example FIG. 6), a respective coupling projection 23 projecting from a respective coupling arm 24 which extends from the pivot axis 12 of the movement element 18 so that a respective coupling projection 23 is arranged at a distance from the pivot axis 12. The coupling projections 23 are arranged accordingly within the coupling recess 22 assigned to them. FIG. 8 is an enlarged detailed view and FIG. 9 is a side sectional view, it being clear from the two drawings how the coupling projections 23 are arranged within the coupling recesses 22. According to the alternative embodiment, a coupling projection in a coupling recess would also be sufficient to implement the movement coupling between the handle body 4 and the movement element 18.

FIG. 10 is an enlarged detailed view of the handle body 4, the force-increasing element 16 and the resistance element 17, whereas FIG. 11 is a perspective illustration of the force increasing element 16. The force-increasing element 16 is designed to be elastically deformable and angled and has a fastening surface 25 which is fastened to a mounting surface 26 formed on the handle body 4, for example by means of a screw connection. An angled spring arm 27 extends from the fastening surface 25 of the force-increasing element 16 toward the resistance element 17 and has a rounded end 28 (see FIG. 11). The rounded end 28 of the force-increasing element 16 lies at least in the idle position of the handle body 4 on a support surface 29 formed on the resistance element 17, as shown for example in FIG. 10. The force-increasing element 16 is consequently arranged between the support surface 29 of the resistance element 17 and the mounting surface 26 formed on the handle body 4, the support surface 29 being formed on a functional body 30 of the resistance element 17 serving multiple functions.

FIGS. 12 to 26 described below show constructional details by means of which the functional body 30 of the resistance element 17 is mounted on the handle body 4 such that it can be moved translationally and rotationally, wherein for the sake of clarity no illustration of the force-increasing element 16 has been given in FIGS. 12 and 13. At least in the idle position of the handle body 4, that is to say in the unactuated state of the door handle assembly 3, the functional body 30 of the resistance element 17 is at least partially inserted into a receiving frame 31 which is adapted to the outer periphery of the functional body 30 and is formed on the handle body 4 (see, for example, FIGS. 12 and 13). A support element 32 (see, for example, FIG. 21) protrudes on opposite side surfaces of the functional body 30 of the resistance element 17. The support elements 32 of the functional body 30 extend laterally from the functional body 30 and parallel to the axis of rotation 10, wherein at least in the idle position of the handle body 4 the pin-shaped support elements 32 are arranged lying on the receiving frame 31 of the handle body 4. If the support elements 32 of the functional body 30 are arranged lying on the receiving frame 31 of the handle body 4, then the resistance element 17 is arranged in a basic position on the handle body 4. In the idle position of the handle body 4, the force-increasing element 16 presses the support elements 32 of the functional body 30 onto the receiving frame 31, as is shown, for example, in FIG. 10. The support elements 32 can be seen, for example, from FIG. 21, pivot pins 33 also being apparent from this illustration, which are formed on opposite sides of the functional body 30 and which are designed to lie between a respective support element 32 and the functional body 30. In the handle body 4, bearing receptacles 34 are formed corresponding to the pivot pin 33. More precisely, the bearing receptacles 34 are formed in the receiving frame 31 of the handle body 4 and, at least in the idle position of the handle body 4, rotatably support the pivot pins 33 of the resistance element 17. At least in the idle position of the handle body 4, the force-increasing element 16 presses the pivot pins 33 into the associated bearing receptacles 34, which is also characteristic of the fact that the resistance element 17 is arranged in its basic position. As can be seen, for example, from FIG. 21, the functional body 30 has two guide arms 35 which are formed on opposite sides of the functional body 30 and are of angled configuration. The guide arms 35 of the resistance element 17 encompass the receiving frame 31 of the handle body 4, the portions of the guide arms 35 running parallel to the axis of rotation 10 having a respective support element 32 and a respective pivot pin 33. In addition, a first guide surface 36 and second guide surfaces 37 are formed on the handle body 4, the second guide surfaces 37 being arranged offset parallel to the first guide surface 36. The first guide surface 36 and the second guide surfaces 37 extend toward the force-increasing element 16 or toward the mounting surface 26, the first guide surface 36 being designed as the inside of the receiving frame 31 (see, for example, FIGS. 27 and 29), whereas the second guide surfaces 37 are arranged and formed centrally on the handle body 4 between the two pivot levers 9 of the handle body 4. The first guide surface 36 and the second guide surfaces 37 are arranged at a distance from one another in such a way that the resistance element 17 can be moved between the first guide surface 36 and the second guide surfaces 37. Finally, a ramp surface 38 is formed on the functional body 30 of the resistance element 17, which is formed on the side of the functional body 30 facing away from the support surface 29 and which rises in a direction pointing towards the carrier 7, as is shown, for example, in FIG. 22. While in FIGS. 12 and 13 the support elements 32 of the functional body 30 are arranged on the receiving frame 31 and the pivot pins 33 in the bearing receptacles 34 of the handle body 4, FIGS. 14 to 16 show a position of the functional body 30 in which the functional body 30 has been moved linearly from the position shown in FIGS. 12 and 13 and is arranged in a translational position in which the support elements 32 and the pivot pins 33 are arranged at a distance from the receiving frame 31. The functional body 30 is consequently arranged translationally with respect to the axis of rotation 10 of the handle body 4 relative to the handle body 4 in its translational position, wherein the translational movement of the resistance element 17 is guided by the first guide surface 36 and the second guide surfaces 37, in that the first guide surface 36 and the second guide surfaces 37 guide the associated side surfaces of the functional body 30, and takes place against a resistance force 39 generated by the force-increasing element 16 (see for example FIG. 16). FIGS. 17 to 20 also show representations in which the resistance element 17 is moved rotationally from a position in which the support elements 32 of the functional body 30 rest on the support frame 31. The rotary movement of the resistance element 17 takes place in the bearing receptacles 34 of the handle body 4 around the pivot pins 33, so that the pivot pins 33 define a rotational axis 40 (see for example FIG. 20) for the resistance element 17. As can be seen from FIGS. 17 and 18, two guide recesses 41 (see for example FIGS. 17 and 18) are formed in the handle body 4, into which the free ends of the guide arms 35 can move when the resistance element 17 rotates, and into which the free ends of the guide arms 35 are arranged when the functional body 30 assumes the rotational position in FIGS. 17 to 20. During a rotary movement of the resistance element 17, the guide recesses 41 consequently guide the movement of the free ends of the guide arms 35. The guide recesses 41 extend in an actuation direction 42 of the handle body 4, the actuation direction 42 (see, for example, FIG. 29) being defined as the direction in which the handle body 4 and/or its pivot lever 9 move(s) from the idle position towards the end position.

Responsible for the translational and rotary movement of the resistance element 17 is the movement element 18 with its movement projection 19, which cooperates with the functional body 30 of the resistance element 17, which is described in more detail below. During movement of the handle body 4 from the idle position toward the end position and during movement of the handle body 4 from a position between the intermediate position and the end position toward the idle position, the functional body 30 of the resistance element 17 is arranged in the movement path of the movement projection 19 of the movement element 18 such that the movement element 18 strives to press the functional body 30 of the resistance element 17 out of the movement path. FIGS. 23 and 24 again show the structural details of the movement element 18, namely the pivot axis 12, the movement projection 19 and the coupling projections 23 for coupling to the handle body 4 so as to transmit a movement. FIGS. 25 and 26 also show two positions which show the interaction of the movement element 18 and the resistance element 17. FIG. 25 shows a position in which the handle body 4 has been moved from the idle position towards the intermediate position, such that the movement projection 19 of the movement element 18 comes into contact with the ramp surface 38 of the resistance element 17 and presses the resistance element 17 linearly or translationally towards the force-increasing element 16. The movement element 18 consequently presses the resistance element 17 from its basic position into its translational position when the handle body 4 moves from its idle position into its intermediate position. FIG. 26, on the other hand, shows a position in which the handle body 4 is moved from the end position toward the idle position, the movement projection 19 of the movement element 18 also coming into contact with the functional body 30 and the functional body 30 rotating or rotationally moving about the rotational axis 40. Consequently, the movement element 18 presses the resistance element 17 from its basic position into its rotational position when the handle body 4 moves from a position lying between the end position and the intermediate position toward its idle position.

The operation of the door handle assembly 3 according to the invention will now be described below with reference to FIGS. 27 to 39. FIGS. 27, 29, 31, 33, 35 and 37 each show a sectional view in which the section runs through the door handle assembly 3 in the center. In contrast, FIGS. 28, 30, 32, 34, 36 and 38 each show a sectional view, in which the section runs shortly before one of the two guide arms 35.

In FIGS. 27 and 28, the handle body 4 is in its idle position, in which the handle body 4 is not actuated, and the resistance element 17 is arranged in the basic position in which the support elements 32 of the functional body 30 rest on the receiving frame 31 of the handle body 4 and the pivot pins 33 of the functional body 30 are arranged in the bearing receptacles 34 of the handle body 4.

In order to initiate a door opening process, the handle body 4 is actuated by a user by pulling on the handle part 4a. During this pulling operation, the handle body 4 is pivoted counterclockwise about the axis of rotation 10 (see arrow 43 in FIG. 29), wherein the movement element 18 rotates clockwise (see arrow 44 in FIG. 29), that is to say in the contrary direction relative to the handle body 4 about the pivot axis 12 due to the coupling of the handle body 4 and the movement element 18. During this movement of the handle body 4 from the idle position toward the intermediate position, the movement projection 19 of the movement element 18 comes into contact with the ramp surface 38 of the functional body 30, as can be seen from FIG. 29. The resistance element 17 is still arranged in its basic position.

If the user then continues to pull on the handle part 4a of the handle body 4, the handle body 4 is pivoted further about the axis of rotation 10 counterclockwise, the movement element 18 pivoting further about the pivot axis 12 in the clockwise direction due to the movement coupling. In FIGS. 31 and 32, the handle body 4 has reached its intermediate position, in which, during normal operation of the door handle assembly 3, the electrical opening of the door 2 takes place in that a button or sensor is triggered in this position in a known manner which sends a signal to the locking system 6 for the electrical opening of the door 2. The pulling actuation of the handle body 4 by a user in the actuation direction 42 takes place against the resistance force 39, which is exerted by the force-increasing element 16 on the resistance element 17. Because during movement of the handle body 4 toward the intermediate position shown in FIG. 31, the movement projection 19 of the movement element 18 presses the resistance element 17 toward the force-increasing element 16 and moves the resistance element 17 translationally along the first guide surface 36 and the second guide surfaces 37. As a result of the translational movement of the resistance element 17, the resistance element 17 compresses the force-increasing element 16, which thereby generates the resistance force 39, which acts in the contrary direction of the translational movement. The force to be exerted for the translational movement of the resistance element 17 makes the user of the door handle assembly 3 feel an increase in force for pivoting the handle body 4. Before attainment of the intermediate position shown in FIGS. 31 and 32, in normal operation of the door handle assembly 3—as already mentioned above—the door 2 is opened electrically, such that a user at most moves the handle body 4 into the intermediate position or beyond the intermediate position unintentionally or if too much force is exerted. In the intermediate position of the handle body 4, the movement projection 19 of the movement element 18 has reached a maximum of the ramp surface 38.

In summary in FIGS. 29 to 32, it should be noted that during movement of the handle body 4 from the idle position into the intermediate position, the movement element 18 rests on the ramp surface 38 and is designed to move the functional body 30 of the resistance element 17 linearly and/or translationally against the resistance force 39 of the force-increasing element 16 toward the force-increasing element 16 with respect to the axis of rotation 10 of the handle body 4 along the first guide surface 36 and the second guide surfaces 37. When the handle body 4 moves from the idle position into the intermediate position, the movement element 18 is consequently designed such that its movement projection 19 moves along the ramp surface 38 and the resistance element 17 linearly or translationally with respect to the axis of rotation 10 of the handle body 4 toward the force increasing element 16, such that the resistance element 17 compresses the force-increasing element 16. In the intermediate position of the handle body 4 shown in FIGS. 31 and 32, the resistance element 17 assumes a translational position. In the translational position of the resistance element 17, the pivot pins 33 of the functional body 30 are arranged at a distance from the bearing receptacles 34 and the support elements 32 of the functional body 30 are arranged at a distance from the receiving frame 31, wherein the functional body 30 is arranged within the receiving frame 31 so as to be translationally displaced relative to its basic position, as is already shown in FIGS. 14 and 16.

An electrical opening of the door can thus take place when the movement projection 19 of the movement element 18 moves along the ramp surface 38 or alternatively also after the intermediate position has been exceeded, wherein the user of the door handle assembly 3 perceives a noticeably increasing resistance due to the force-increasing element 16 when the functional body 30 is translationally moved, whereas, when the intermediate position is exceeded, the force to be applied by the user to pivot the handle body 4 noticeably decreases and the exceeding may be accompanied by an acoustic noise which signals to the user that he/she has reached or exceeded the actuation point for electrically opening the door 2.

In FIGS. 33 and 34, the handle body 4 is now maximally operated by a user and arranged in its end position. After passing through the intermediate position of the handle body 4, the resistance element 17 is now arranged in its basic position again. After the movement projection 19 of the movement element 18 has passed the ramp surface 38 of the functional body 30, the force-increasing element 16, due to its elasticity, presses the resistance element 17 out of the translational position (see FIGS. 31 and 32) into its basic position (see FIGS. 33 and 34), such that the support elements 32 rest again on the receiving frame 31 of the handle body 4 and the pivot pins 33 of the functional body 30 are arranged again in the bearing receptacles 34 of the handle body 4. When the handle body 4 moves, the movement element 18 is spaced apart from the ramp surface 38 beyond the intermediate position up to the end position.

When the handle body 4 moves from the idle position into the end position, the movement projection 19 of the movement element 18 thus moves past the functional body 30 of the resistance element 17 and moves the resistance element 17, which is arranged in the movement path of the movement element 18, at least temporarily translationally toward the force-increasing element 16, as shown in FIGS. 27 to 34.

During movement of the handle body 4 from the end position toward the intermediate position, the movement projection 19 of the movement element 18 moves towards the functional body 30 and comes into contact with the functional body 30, as can be seen in FIGS. 35 and 36. The movement projection 19 of the movement element 18 lies against a side surface 45 of the functional body 30 adjoining the ramp surface 38. The functional body 30, due to its mounting of the pivot pin 33 in the bearing receptacles 34, now has the freedom of movement to rotate about the pivot pin 33, which define the rotational axis 40, when the movement projection 19 of the movement element 18 engages back to its idle position on the functional body 30 and presses against it as a result of the movement of the handle body 4. FIGS. 35 and 36 show a position in which the functional body 30 has already been rotated counterclockwise about the rotational axis 40 in the bearing receptacles 34, wherein the handle body 4 rotates clockwise 44 about the axis of rotation 10 and the movement element 18, which is coupled to the handle body 4 so as to transmit a movement, rotates counterclockwise 43 about the pivot axis 12. As has already been described for FIGS. 17 to 20, when the handle body 4 moves from the end position into the idle position, the two guide arms 35 are at least temporarily arranged lying and guided in the guide recesses 41 of the handle body 4, wherein the movement element 18 comes into contact with the functional body 30 and rotationally moves the functional body 30 having its two pivot pins 33 arranged in the corresponding bearing receptacles 34 against the direction of rotation of the handle body 4 in the bearing receptacles 34 about the rotational axis 40. In FIGS. 35 and 36, the resistance element 17 assumes a rotational position in which the resistance element 17 is arranged in the bearing receptacles 34 from the basic position, rotated about the rotational axis 40.

When the handle body 4 moves from the end position back to the idle position, the movement projection 19 of the movement element 18 thus moves past the functional body 30 of the resistance element 17 and rotates the resistance element 17, which is arranged in the movement path of the movement element 18, at least temporarily around the rotational axis 40 and from the path of movement of the movement element 18, wherein the direction of rotation of the functional body 30 is directed against the direction of rotation of the handle body 4.

In summary, a door handle assembly 3 according to the invention has been described above, which is characterized by the force-increasing device 21, which noticeably increases the operating resistance for a user when the handle body 4 is actuated. The force-increasing device 21 comprises the force-increasing element 16, which produces the resistance force 39 and is fastened to the handle body 4, the resistance element 17, which interacts with the force-increasing element 16 and is mounted on the handle body 4, and the movement element 18, which is designed, during movement of the handle body 4 from the idle position until the attainment of the intermediate position, to move the resistance element 17 translationally toward the force-increasing element 16 against the resistance force 39 produced by the force-increasing element 16 relative to the axis of rotation 10 and, during movement of the handle body 4 from the end position into the idle position, to move the resistance element 17 rotationally relative to a rotational axis 40 of the handle body 4.

The described invention is of course not limited to the described and illustrated embodiment. In particular, the invention is applicable to all types of door handle assemblies and in particular is not limited to pull handles with a substantially vertical pivot axis. It is also suitable for folding handles and pull-pivot handles having an inclined pivot axis. It can thus be seen that numerous modifications can be made to the embodiment shown in the drawing which are obvious to the person skilled in the art according to the intended application, without thereby departing from the scope of the invention. The invention includes everything that is contained in the description and/or depicted in the drawing, including anything that, deviating from the concrete design example, is obvious to the person skilled in the art.

1. Door handle assembly of a motor vehicle, comprising a carrier which can be fastened on a door or trunk lid of the motor vehicle, a handle body, which is mounted on the carrier for pivoting about an axis of rotation and can be moved from an idle position into an end position, and a force-increasing device, which is designed, during movement of the handle body from the idle position into the intermediate position, to produce a resistance force counteracting the movement of the handle body,
wherein
the force-increasing device comprises a force-increasing element, which produces the resistance force and is fastened to the handle body, a resistance element, which interacts with the force-increasing element and is mounted on the handle body, and a movement element, which is designed, during movement of the handle body from the idle position into the intermediate position, to move the resistance element translationally toward the force-increasing element against the resistance force produced by the force-increasing element relative to the axis of rotation and, during movement of the handle body from the end position into the idle position, to move the resistance element rotationally relative to a rotational axis of the handle body.

2. Door handle assembly according to claim 1, wherein the movement element is designed as a movement projection projecting from a base body mounted on the carrier.

3. Door handle assembly according to claim 1, wherein the movement element is pivotably mounted on the carrier via a pivot axis, wherein the handle body and the movement element are coupled together so as to transmit a movement and rotate in contrary directions about the axis of rotation and the pivot axis during movement of the handle body.

4. Door handle assembly according to claim 3, wherein the handle body has at least one pivot lever connected to the axis of rotation, on which a coupling recess is formed, wherein the movement element has at least one coupling arm, on which a coupling projection is formed, which is arranged in the coupling recess of the at least one pivot lever of the handle body.

5. Door handle assembly according to claim 1, wherein the resistance element has a functional body having a support surface, wherein the functional body is inserted at least in sections in a receiving frame formed on the handle body and the force-increasing element is arranged between the support surface of the functional body and a mounting surface formed on the handle body.

6. Door handle assembly according to claim 5, wherein the functional body of the resistance element has at least one support element projecting laterally from the functional body, wherein the at least one support element is arranged lying on the receiving frame in the idle position of the handle body and the force-increasing element presses the supporting element onto the receiving frame.

7. Door handle assembly according to claim 6, wherein the handle body has at least one first guide surface and at least one second guide surface which is parallel to the at least one first guide surface, wherein a ramp surface is formed on the functional body, which ramp surface is formed on the side of the functional body facing away from the support surface and which rises in a direction pointing towards the carrier.

8. Door handle assembly according to claim 7, wherein during movement of the handle body from the idle position into the intermediate position, the movement element rests on the ramp surface and is designed to move the functional body of the resistance element linearly and/or translationally against the resistance force of the force-increasing element in the direction of the force-increasing element with respect to the axis of rotation of the handle body along the at least one first guide surface and the at least one second guide surface.

9. Door handle assembly according to claim 7, wherein during movement of the handle body beyond the intermediate position up to the end position, the movement element is spaced apart from the ramp surface beyond the intermediate position up to the end position and the at least one support element is arranged lying on the receiving frame.

10. Door handle assembly according to claim 5, wherein two pivot pins are formed on two opposite sides of the functional body of the resistance element, which are rotatably mounted at least in the idle position of the handle body in corresponding bearing receptacles, which are formed in the receiving frame of the handle body, wherein the pivot pins form the rotational axis.

11. Door handle assembly according to claim 10, wherein during movement of the handle body from a position lying between the intermediate position and the end position into the idle position, the movement element comes into contact with the functional body and is designed to rotationally move the functional body having its two pivot pins arranged in the corresponding bearing receptacles against the direction of rotation of the handle body in the bearing receptacles with respect to the rotational axis.

12. Door handle assembly according to claim 10, wherein the functional body has two guide arms formed on opposite sides and angled and the handle body has two guide recesses which extend in an actuation direction of the handle body, wherein during movement of the handle body from a position lying between the intermediate position and the end position toward the idle position, the two guide arms are arranged lying and guided in the guide recesses of the handle body.
